(19) United States
(12) Patent Application Publication
(10) Pub. No.: US 2008/0126644 A1
(43) Pub. Date: May 29, 2008

(54) System for generating access conflict in access conflict test

(75) Inventors: Kouichi Kawarabata, Fukuoka (JP); Akira Hatae, Fukuoka (JP); Kazuhisa Matsumoto, Fukuoka (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/998,068

(22) Filed: Nov. 28, 2007

(30) Foreign Application Priority Data
Nov. 28, 2006 (JP) 2006-320263

(51) Int. Cl. G06F 13/364

(52) U.S. Cl. 710/113

(57) ABSTRACT

To provide a system for generating access conflict capable of immediately realizing secure access conflict between access signals in an access conflict test. First and second test-access signals (Sₘ and S₍ₘ₊₁₎) similar to real access signals to be output from first and second interfaces, respectively, are stored in storing part, and first and second local-bus controlling part are provided for the first and second interfaces, respectively. The first and second test-access signals are successively output to the first and second local-bus controlling part, respectively, by test-access-signal outputting part. Access observing part is provided for an arbitration unit. The first and second test-access signals include an identical time (t) serving as a send timing interval at which the signals are to be sent from the first and second local-bus controlling part, respectively, to the access observing part. Test-access generating part is provided for each of the first and second local-bus controlling part for sending the first and second test-access signals, respectively, to the access observing part on the basis of the send timing interval.

### BACKGROUND OF THE INVENTION

1. Field of the Invention

The present invention generally relates to access conflict tests for examining whether or not various access signals are appropriately processed when the access signals conflict with each other in devices connected to general-purpose processors, and more specifically, it relates to systems for generating access conflict in the access conflict tests.

2. Description of the Related Art

In FIG. 12, an overview of a known processor module is shown using reference number 1. This processor module 1 includes a general-purpose processor 11, a bus controller 12, an external memory 13, a general-purpose memory 14, a PCI (peripheral component interconnect) bridge 15, a debug interface 16, PCI devices 17 and 18, and the like installed therein.

The bus controller 12 includes an arbitration unit 12A, a processor interface 12B, a memory interface 12C, a general-purpose memory interface 12D, a bus interface 12E, an intersystem bus interface 12F, and the like. The arbitration unit 12A has a function of arbitrating between access signals output from the processor interface 12B, the memory interface 12C, the general-purpose memory interface 12D, the bus interface 12E, the intersystem bus interface 12F, and the like when the access signals conflict with each other. That is, higher-priority access signals are processed first, and lower-priority access signals are processed afterward when the access signals conflict with each other. In an access conflict test, it is examined whether or not the access signals are appropriately processed in this manner.

The general-purpose processor 11 is connected to the arbitration unit 12A via the processor interface 12B. The general-purpose processor 11 generates various access signals in accordance with the contents of programs executed therein, and these access signals are sent to the arbitration unit 12A via the processor interface 12B.

The external memory 13 can be, for example, a DRAM, and is connected to the arbitration unit 12A via the memory interface 12C. Various command signals, data on operation results, and the like obtained while the programs are executed in the general-purpose processor 11 are temporarily stored in the external memory 13.

The general-purpose memory 14 can be, for example, a flash memory, and is connected to the arbitration unit 12A via the general-purpose memory interface 12D. Various diagnostic programs, test programs, and the like are stored in the general-purpose memory 14. The diagnostic programs, the test programs, and the like are not directly related to the access conflict test.

The PCI bridge 15 is connected to the arbitration unit 12A via the bus interface 12E. Moreover, the PCI bridge 15 is connected to the debug interface 16 and the PCI devices 17 and 18. The debug interface 16, which is connected to a peripheral device and the like while the processor module 1 is operated in practice, is connected to a test terminal P1 during the access conflict test. Moreover, the PCI devices 17 and 18 are connected to, for example, the Internet. Access signals are artificially generated at the test terminal P1 during the access conflict test, and these access signals are sent to the arbitration unit 12A via the debug interface 16 and the PCI bridge 15.

The processor module 1 shown in FIG. 12 has a redundant function serving as a safety system. That is, a counter-processor module (not shown) similar to the processor module 1 is prepared. This counter-processor module is connected to the intersystem bus interface 12F via an intersystem bus SB1, and access signals generated at the counter-processor module are sent to the arbitration unit 12A via the intersystem bus interface 12F.

When the access conflict test is conducted in the processor module 1 shown in FIG. 12, three access signals described above are used. That is, a processor access signal AR1 generated while a test program is executed at the general-purpose processor 11, a debug access signal AR2 artificially generated at the test terminal P1, and an intersystem access signal AR3 generated at a general-purpose processor in the counter-processor module (not shown) and transferred via the intersystem bus 3 are used. The intersystem access signal AR3 is either the processor access signal or the debug access signal generated in the counter-processor module.

In FIG. 12, access using the processor access signal AR1, access using the debug access signal AR2, and access using the intersystem access signal AR3 to the arbitration unit 12A are symbolically indicated by arrows AR1, AR2, and AR3, respectively.

In the access conflict test, access conflict of the debug access signal AR2 with the processor access signal AR1 or the intersystem access signal AR3 is artificially generated at the arbitration unit 12A, and it is examined whether or not the access conflict has been appropriately processed in the arbitration unit 12A at this moment. One of the problems in the access conflict test in the above-described known processor module 1 is difficulty in artificially generating the access conflict of the debug access signal with the processor access signal or the intersystem access signal. That is, since the access using the processor access signal, the access using the debug access signal, and the access using the intersystem access signal to the arbitration unit 12A are independently controlled in the processor module 1, occurrence of access conflict cannot always be ensured reliably. Although timing of generating the debug access signal can be adjusted at the test terminal P1 as a matter of course, the adjustment needs to be carried out on a so-called trial-and-error basis. Therefore, the access conflict test conducted in the processor module 1 is significantly complicated and requires much time. It can be checked by the test terminal P1 whether or not the signals are appropriately processed in the arbitration unit 12A when the access conflict occurs.

Moreover, another problem in the access conflict test in the above-described known processor module 1 is that the general-purpose processor 11 needs to be operated in practice during the access conflict test. Therefore, programs executed in the processor module 1 and the general-purpose processor 11 need to be completed before conducting the access conflict test, and the access conflict test cannot be conducted until all the problems, for example, delay in the specification determination of components constituting the processor module, delay in the development of some of components, sudden changes of components, delay in programming, and bugs in the programs, are solved and the product is fully completed. Accordingly, it is difficult to conduct a test of the arbitration unit during development.

### SUMMARY

In short, a known system for generating access conflict has problems such as low reliability, expense of time and effort in the access conflict test, and delay in commercialization of the processor module and the like.

Therefore, an object of the present invention is to provide a system for generating access conflict capable of immediately realizing secure access conflict between access signals in an access conflict test.

Another object of the present invention is to provide a system for generating access conflict capable of reliably ensuring occurrence of access conflict, for example, a system for generating access conflict capable of conducting an access conflict test even when a program of a processor in a device such as a processor module is not yet completed.

A system for generating access conflict according to a first aspect of the present invention is embedded in a device including an arbitration unit and first and second interfaces, and includes storing part that stores first and second test-access signals similar to real access signals to be output from the first and second interfaces, respectively; first and second local-bus controlling part provided for the first and second interfaces, respectively; test-access-signal outputting part for successively outputting the first and second test-access signals to the first and second local-bus controlling part, respectively; and access observing part provided for the arbitration unit. The first and second test-access signals include an identical time serving as a send timing interval at which the signals are to be sent from the first and second local-bus controlling part, respectively, to the access observing part. The system for generating access conflict further includes—access generating part provided for each of the first and second local-bus controlling part for sending the first and second test-access signals, respectively, to the access observing part on the basis of the send timing interval.

According to the first aspect of the present invention, the send timing interval is set to the longer processing time of the processing time required for a real access signal to be processed at the first interface and the processing time required for a real access signal to be processed at the second interface.

Moreover, according to the first aspect of the present invention, the test-access-signal outputting part includes command generating part that generates read commands to read the first and second test-access signals from the storing part and destination determining part for determining destinations of the first and second test-access signals.

Furthermore, the system for generating access conflict according to the first aspect of the present invention can include time-difference creating part that creates a time difference between the first and second test-access signals reaching the access observing part, the first and second test-access signals being sent from the first and second local-bus controlling part, respectively, to the access observing part. In this case, the system for generating access conflict can further include time-difference accumulating part for accumulating the time difference.

A system for generating access conflict according to a second aspect of the present invention is embedded in a device including an arbitration unit and first and second interfaces, and includes storing part that stores at least two test-access signals similar to real access signals to be output from the first interface; first local-bus controlling part provided for the first interface; test-access-signal outputting part for successively outputting the test-access signals to the first local-bus controlling part; and access observing part provided for the arbitration unit. The test-access signals each include a send timing interval at which the signals are to be sent from the first local-bus controlling part to the access observing part. The system for generating access conflict further includes second local-bus controlling part provided for the second interface, real access signals being output from the second interface to the second local-bus controlling part at constant output intervals. The system for generating access conflict further includes time-difference creating part for creating a time difference between the constant output interval of the real access signals and the send timing interval when the test-access signal is sent from the first local-bus controlling part to the access observing part on the basis of the send timing interval; and send-timing-interval adjusting part for adjusting the send timing interval of the next test-access signal using the time difference when the next test-access signal is sent from the storing part to the first local-bus controlling part by the test-access-signal outputting part such that the next test-access signal conflict with the corresponding real access signal.

According to the second aspect of the present invention, the send timing interval is set to a value smaller than the constant output interval.

Moreover, according to the second aspect of the present invention, the test-access-signal outputting part includes command generating part that generates read commands to read the test-access signals from the storing part and destination determining part for determining destinations of the test-access signals.

Moreover, the system for generating access conflict according to the second aspect of the present invention further includes time-difference accumulating part for accumulating the time difference.

### BRIEF DESCRIPTION OF THE DRAWINGS

FIG. 1 is a schematic block diagram of a processor module into which a system for generating access conflict according to the present invention is integrated;

FIG. 2 is a detailed block diagram of a conflict control unit shown in FIG. 1;

FIG. 3 is a schematic view of test-access signals written in an internal memory shown in FIG. 2 when the system for generating access conflict shown in FIG. 1 is operated in a first operation mode;

FIG. 4 is a schematic view of a test-access signal written in the internal memory shown in FIG. 2 when the system for generating access conflict shown in FIG. 1 is operated in a second operation mode;

FIG. 5 is a detailed block diagram of a LB controlling section provided for each interface shown in FIG. 1;

FIG. 6 is a detailed block diagram of the conflict observation unit provided for an arbitration unit shown in FIG. 1;

FIG. 7 is a schematic view of a conflict-generation setting register provided for a conflict-information processing section of the conflict control unit shown in FIG. 6;

FIG. 8 illustrates operations of the system for generating access conflict shown in FIG. 1 operated in the first operation mode;

FIG. 9 illustrates the sequence of the operations of the system for generating access conflict shown in FIG. 1 operated in the first operation mode;

FIG. 10 illustrates operations of the system for generating access conflict shown in FIG. 1 operated in the second operation mode;

FIG. 11 illustrates the sequence of the operations of the system for generating access conflict shown in FIG. 1 operated in the second operation mode; and

FIG. 12 is a block diagram of a processor module that conducts access conflict tests using a known system for generating access conflict.

### DESCRIPTION OF THE PREFERRED EMBODIMENTS

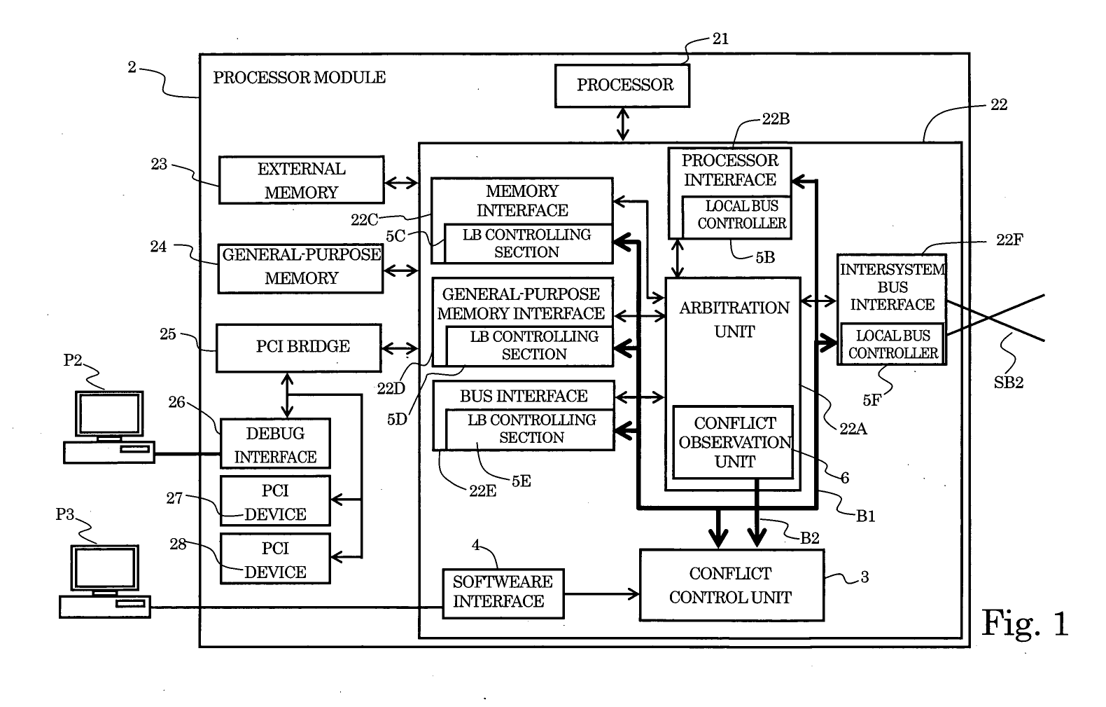

First, in FIG. 1, an overview of a processor module including a system for generating access conflict according to the present invention is shown using reference number 2.

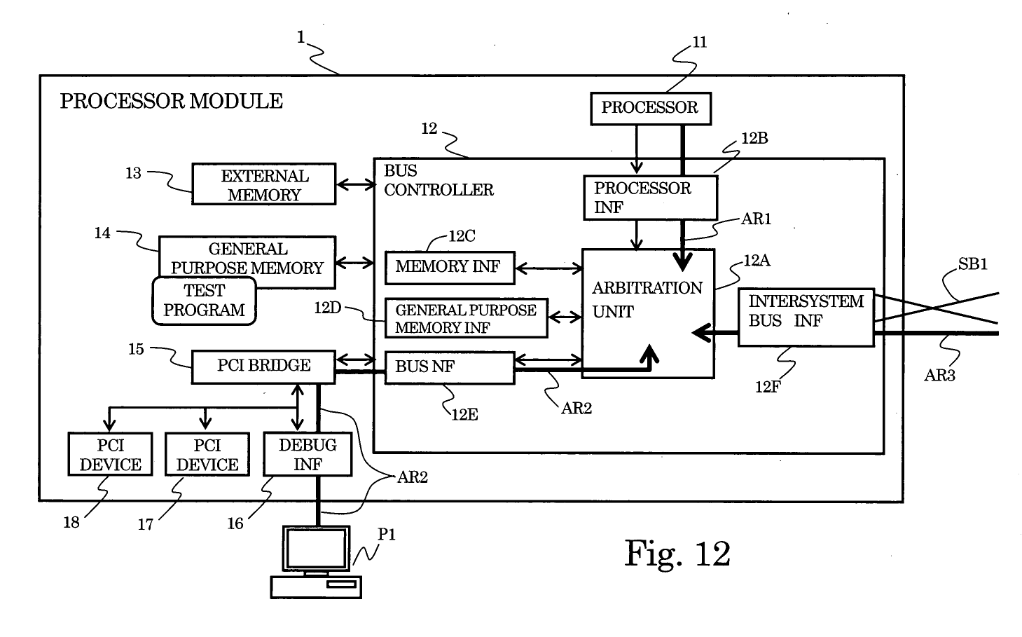

As in the known processor module 1 shown in FIG. 12, the processor module 2 includes a general-purpose processor 21, a bus controller 22, an external memory 23, a general-purpose memory 24, a PCI bridge 25, a debug interface 26, PCI devices 27 and 28, and the like installed therein. The debug interface 26, which is connected to a peripheral device and the like while the processor module 2 is operated in practice, is connected to a test terminal P2 during an access conflict test. As in the conventional access conflict test, it can be checked by this test terminal P2 whether or not the signals are appropriately processed in an arbitration unit 22A when the access conflict occurs.

In addition, as in the bus controller 12 shown in FIG. 12, the bus controller 22 includes the arbitration unit 22A, a processor interface 22B, a memory interface 22C, a general-purpose memory interface 22D, a bus interface 22E, and an intersystem bus interface 22F.

As in the conventional case shown in FIG. 12, the processor module 2 also has a redundant function serving as a safety system. That is, a counter-processor module (not shown) similar to the processor module 2 is prepared. This counter-processor module is connected to the intersystem bus interface 22F via an intersystem bus SB2, and access signals generated at the counter-processor module are sent to the arbitration unit 12A via the intersystem bus interface 22F as intersystem access signals.

The system for generating access conflict includes a conflict control unit 3 and a software interface 4 provided for the bus controller 22, and the conflict control unit 3 is connected to a test terminal P3 via the software interface 4.

Moreover, the system for generating access conflict includes local-bus (LB) controlling sections 5B, 5C, 5D, 5E, and 5F provided for the processor interface 22B, the memory interface 22C, the general-purpose memory interface 22D, the bus interface 22E, and the intersystem bus interface 22F, respectively. The LB controlling sections 5B to 5F are connected to the conflict control unit 3 via a local bus B1. The LB controlling sections 5B to 5F have the same structure. The LB controlling sections 5B to 5F are provided for the interfaces 22B to 22F, respectively, at positions adjacent to the arbitration unit 22A. When the bus controller 22 is formed of an FPGA, a conflict test can be conducted even when specifications or circuits of any of the interfaces 22B to 22F are not yet completed. When the LB controlling sections 5B to 5F are disposed at positions remote from the arbitration unit, a conflict test including the circuits of the interfaces 22B to 22F can be conducted. However, in this case, the LB controlling sections 5B to 5F need to have structures that are in accordance with the circuits of the interfaces 22B to 22F, respectively, and at the same time, test-access signals also need to be in accordance with the interfaces 22B to 22F, resulting in complicated designing.

Furthermore, the system for generating access conflict includes a conflict observation unit 6 provided for the arbitration unit 22A. This conflict observation unit 6 is connected to the conflict control unit 3 via a local bus B2.

When the processor module 2 is operated in practice, various access signals are sent from the processor interface 22B, the memory interface 22C, the general-purpose memory interface 22D, the bus interface 22E, and the intersystem bus interface 22F to the arbitration unit 22A. At this moment, an access conflict of the access signals can occur in the arbitration unit 22A. As described above with reference to FIG. 12, it is examined whether or not the access signals are appropriately processed when the access conflict occurs in the arbitration unit 22A in an access conflict test.

When an access conflict test is conducted in the processor module 2 shown in FIG. 1, the system for generating access conflict is operated in one of two operation modes.

In a first operation mode, an access conflict is generated using only test-access signals created in the conflict control unit 3 so that an access conflict test is conducted. That is, access signals obtained while the processor module 2 is operated in practice are not used at all.

An outline of operations in the first operation mode will now be described although those in the first operation mode will be described in detail below. Test-access signals similar to access signals output from the above-described various interfaces 22B to 22F while the processor module 2 is operated in practice are created in the conflict control unit 3, and these test-access signals are successively output to the LB controlling sections 5B to 5F of the interfaces 22B to 22F, respectively, via the local bus B1. Subsequently, the test-access signals are sent from two of the LB controlling sections 5B to 5F, for example, from those of the processor interface 22B and the intersystem bus interface 22F to the arbitration unit 22A and the conflict observation unit 6 at a predetermined timing so as to generate an access conflict. Next, it is determined whether or not the test-access signals conflict with each other in the conflict observation unit 6, and the determination is sent to the conflict control unit 3 via the local bus B2 so as to be accumulated therein as a piece of information on the conflict state. After all the test-access signals are sent from the conflict control unit 3 to the LB controlling sections 5B to 5F, an examiner can check the pieces of information on the conflict state accumulated in the conflict control unit 3 via the test terminal P3.

In a second operation mode, an access conflict test is conducted under a condition where one of the various interfaces 22B to 22F in the processor module 2 is operated in practice and real access signals are sent therefrom to the arbitration unit 22A.

An outline of operations in the second operation mode will now be described although those in the second operation mode will be described in detail below. When one of the various interfaces 22B to 22F, for example, the processor interface 22B is operated in practice, test-access signals to be output to the LB controlling sections 5C to 5F excluding the LB controlling section 5B of the processor interface 22B are created in the conflict control unit 3, and these test-access signals are successively sent to the LB controlling sections 5C to 5F of the interfaces 22C to 22F, respectively, via the local bus B1. Subsequently, a test-access signal is sent from one of the LB controlling sections 5C to 5F to the arbitration unit 22A and the conflict observation unit 6 at a predetermined timing. Next, it is determined whether or not the test-access signal output from one of the LB controlling sections 5C to 5F conflicts with a real access signal output from the processor interface 22B in the conflict observation unit 6. The determination is sent to the conflict control unit 3 via the local bus B2 as information on the conflict state, and the test-access signals to be sent from the conflict control unit 3 to the LB controlling sections 5C to 5F are processed so as to conflict with the real access signals output from the processor interface 22B in the arbitration unit 22A on the basis of the information on the conflict state.

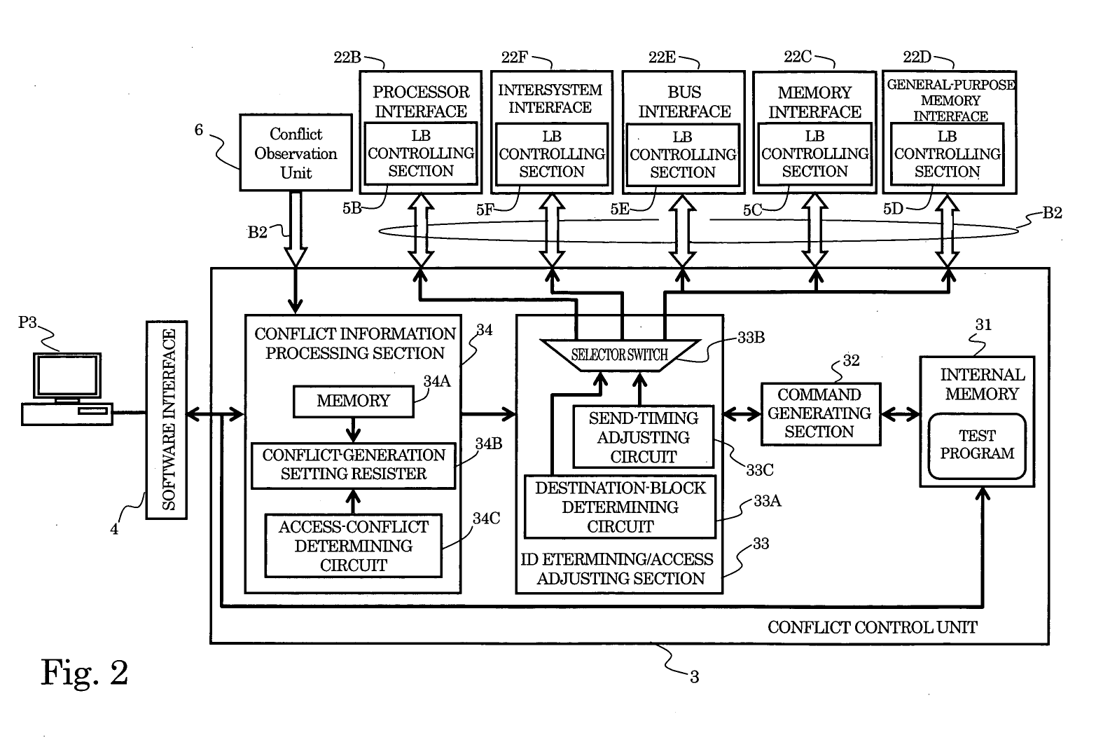

Next, the structure of the conflict control unit 3 will be described with reference to FIG. 2, which is a detailed block diagram of the conflict control unit 3 shown in FIG. 1.

The conflict control unit 3 includes an internal memory 31, a command generating section 32, an ID determining/access adjusting section 33, and a conflict-information processing section 34.

A program for the access conflict test is stored in the internal memory 31. The program for the access conflict test includes various test-access signals. These test-access signals can be created using the test terminal P3 via the software interface 4, and in addition, the contents of the test-access signals can be rewritten.

When the system for generating access conflict is in the first operation mode, the program for the access conflict test includes pairs of test-access signals to conflict with each other, the pairs being successively arranged.

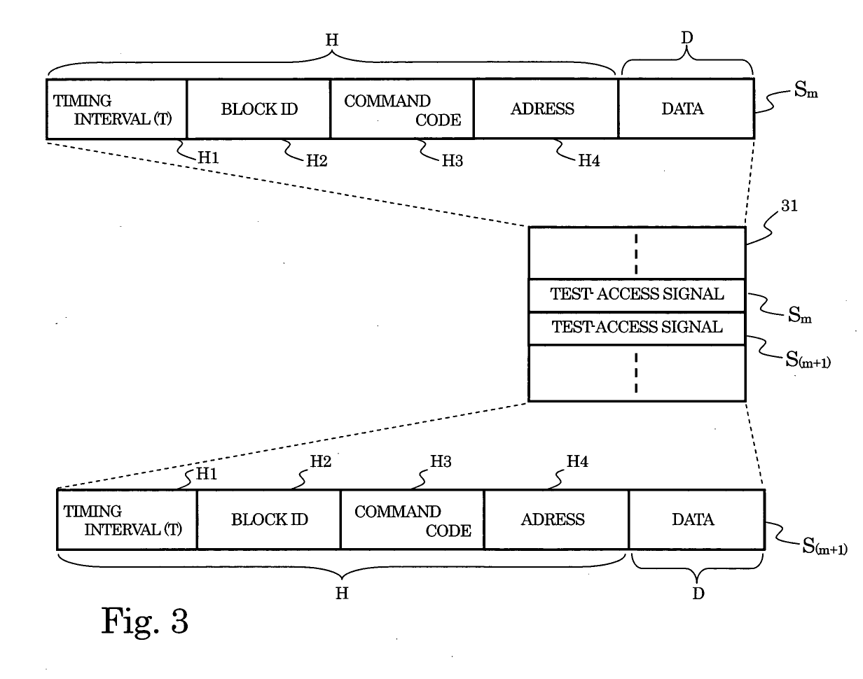

Packet formats of a pair of test-access signals Sₘ and S₍ₘ₊₁₎ written in the internal memory 31 when the first operation mode is selected are schematically and illustratively shown in FIG. 3. The test-access signals Sₘ and S₍ₘ₊₁₎ in the pair are to conflict with each other in the arbitration unit 22A. As shown in FIG. 3, each of the test-access signals Sₘ and S₍ₘ₊₁₎ can be sectioned into a header area H and a data area D, and the header area H can be further sectioned into four regions H1, H2, H3, and H4.

An identical time t serving as a send timing interval for sending the test-access signals Sₘ and S₍ₘ₊₁₎ from the LB controlling sections 5B to 5F to the arbitration unit 22A is written in each of the regions H1 of the test-access signals Sₘ and S₍ₘ₊₁₎. The send timing interval t is determined as follows.

For example, it is assumed that a test-access signal Sₘ is sent to the LB controlling section 5B of the processor interface 22B, and a test-access signal S₍ₘ₊₁₎ is sent to the LB controlling section 5F of the intersystem bus interface 22F. In a case when the bus controller 22 is operated in practice, the processing time between when the access signal is input to the processor interface 22B and when the access signal is output therefrom after being appropriately processed is defined as t_{B}, and the processing time between when the access signal is input to the intersystem bus interface 22F and when the access signal is output therefrom after being appropriately processed is defined as t_{F}. When t_{B}>t_{F} is satisfied, the send timing interval t is set to the processing time t_{B}. On the other hand, when t_{B}<t_{F} is satisfied, the send timing interval t is set to the processing time t_{F}. In short, the send timing interval t is set to the longer processing time. Processing times required for processing access signals in the above-described various interfaces 22B to 22F can be found in one design phase.

Destination data indicating which of the LB controlling sections (5B, 5C, 5D, 5E, and 5F) of the processor interface 22B, the memory interface 22C, the general-purpose memory interface 22D, the bus interface 22E, and the intersystem bus interface 22F, respectively, the test-access signals Sₘ and S₍ₘ₊₁₎ are sent to is written in the regions H2 as block IDs.

Command codes of the test-access signals Sₘ and S₍ₘ₊₁₎ are written in the regions H3. For example, command codes for distinguishing whether the test-access signals Sₘ and S₍ₘ₊₁₎ are write signals, read signals, interrupt signals, or the like are written in the regions H3. The addresses of the test-access signals are written in the regions H4.

Predetermined data is written in the data areas D. The content of the data is not directly related to the access conflict test. The test-access signals also include pure command signals, and such command signals do not have any data areas D.

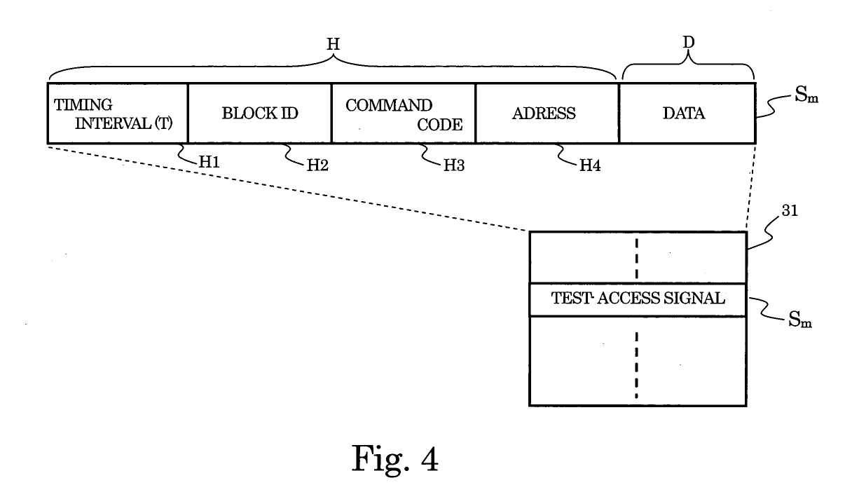

A packet format of a test-access signal Sₙ written in the internal memory 31 when the second operation mode is selected is schematically and illustratively shown in FIG. 4. The test-access signals Sₙ is used for generating access conflict in the arbitration unit 22A. As shown in FIG. 4, the test-access signals Sₙ is sectioned into a header area H and a data area D, and the header area H is further sectioned into four regions H1, H2, H3, and H4 as in the first operation mode.

When the second operation mode is selected, an identical time T serving as a send timing interval for sending test-access signals Sₙ from any one of the LB controlling sections 5B to 5F to the arbitration unit 22A is written in each of the regions H1 of all the test-access signals. The send timing interval T corresponds to a read interval for reading the signals from the internal memory 31. When real access signals are successively sent from the processor interface 22B to the arbitration unit 22A at predetermined constant intervals T_{C} as in the above-described example, the send timing interval T is set to a value slightly smaller than T_{C}.

Moreover, when the second operation mode is selected, a test-access signal Sₙ does not conflict with the next test-access signal Sₙ₊₁ as described above. Therefore, in a case when real access signals are successively sent from the processor interface 22B to the arbitration unit 22A, destination data indicating which of the LB controlling sections 5C, 5D, 5E, and 5F excluding the LB controlling section 5B of the processor interface 22B each test-access signal Sₙ is sent to is written in the region H2 of the test-access signal Sₙ (see FIG. 3) as a block ID.

The contents written in the other regions H3 and H4 and the area D of each test-access signal Sₙ are the same as those shown in FIG. 3.

Again, with reference to FIG. 2, the command generating section 32 successively reads the test-access signals Sₘ or Sₙ from the internal memory 31. Moreover, the command generating section 32 decodes the contents of the command codes (H3) of the read test-access signals into the access format of the processor module 2. After decoding, the test-access signals Sₘ or Sₙ are output to the ID determining/access adjusting section 33.

The ID determining/access adjusting section 33 includes a destination-block determining circuit 33A, a selector switch 33B, and a send-timing adjusting circuit 33C.

The destination-block determining circuit 33A determines destination data from the block IDs (H2) of the test-access signals Sₘ or Sₙ output from the command generating section 32. The selector switch 33B is switched on the basis of this determination. For example, when it is determined that the destination of the test-access signals Sₘ or Sₙ is the processor interface 22B from the block IDs, the selector switch 33B is switched such that the test-access signals are sent to the LB controlling section 5B of the processor interface 22B. On the other hand, when it is determined that the destination of the test-access signals Sₘ or Sₙ is the intersystem bus interface 22F from the block IDs, the selector switch 33B is switched such that the test-access signals Sₘ or Sₙ are sent to the LB controlling section 5F of the intersystem bus interface 22F.

The send-timing adjusting circuit 33C is used only when the system for generating access conflict according to the present invention is in the second operation mode. The send-timing adjusting circuit 33C adjusts the send timing interval T by adding a correction time ΔT to the send timing interval T of each of the test-access signals Sₙ. The test-access signals Sₙ are output to the local bus B1 after the adjustment of the send timing intervals T, and sent to any one of the LB controlling sections 5B to 5F in accordance with the destination data on the block IDs. The correction time ΔT, which will be described in detail below, is included in the information on the conflict state.

Strictly speaking, the send-timing adjusting circuit 33C is also operated in practice when the first operation mode is selected. In this case, the correction time is set to zero, and the test-access signals Sₘ are sent to any one of the LB controlling sections 5B to 5F without the adjustment of the send timing intervals t in accordance with the destination data on the block IDs.

The conflict-information processing section 34 includes a memory 34A, a conflict-generation setting register 34B, and an access-conflict determining circuit 34C.

When the system for generating access conflict is either in the first operation mode or in the second operation mode, pieces of the information on the conflict state output from the conflict observation unit 6 of the arbitration unit 22A via the local bus B2 are successively stored and accommodated in the memory 34A. The pieces of information on the conflict state can be checked via the test terminal P3.

The conflict-generation setting register 34B is operated only when the second operation mode is selected. The information on the conflict state is written in the conflict-generation setting register 34B each time a piece of information on the conflict state is output from the conflict observation unit 6 of the arbitration unit 22A via the local bus B2, and it is determined whether or not an access conflict has occurred on the basis of the correction time ΔT included in the information on the conflict state by the access-conflict determining circuit 34C. When it is determined that no access conflict has occurred by the access-conflict determining circuit 34C, the correction time ΔT is output to the send-timing adjusting circuit 33C of the ID determining/access adjusting section 33.

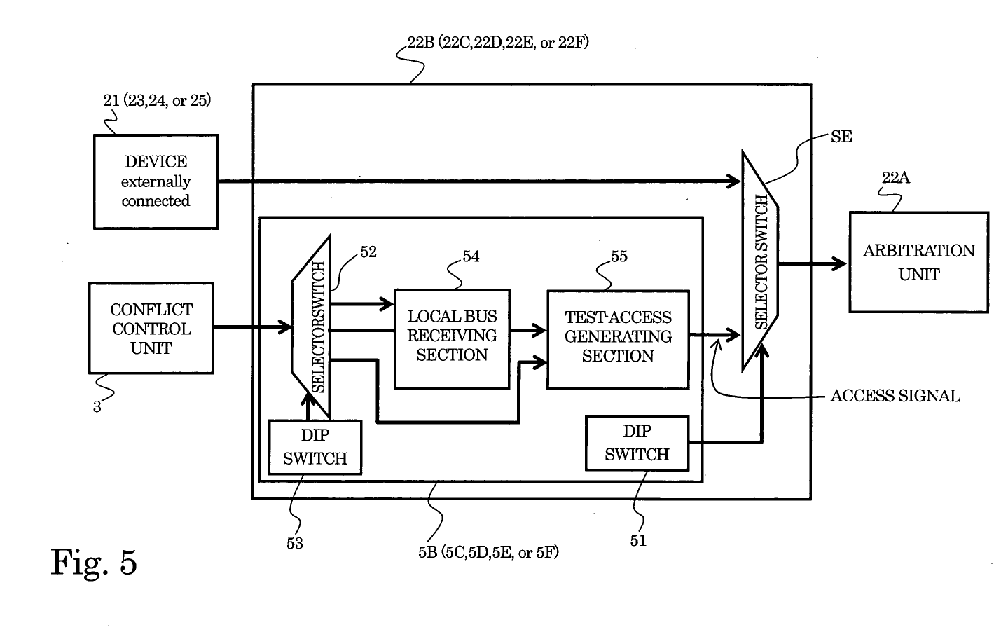

Next, the structure of the LB controlling sections 5B to 5F will be described with reference to FIG. 5, which is detailed block diagrams of the LB controlling sections 5B to 5F shown in FIG. 1. In FIG. 5, an interface processing block represents the processor interface 22B, the memory interface 22C, the general-purpose memory interface 22D, the bus interface 22E, and the intersystem bus interface 22F. Moreover, an external device represents the general-purpose processor 21, the external memory 23, the general-purpose memory 24, and the PCI bridge 25 connected to the interface processing block.

The interface processing block (22B, 22C, 22D, 22E, or 22F) includes a selector switch SE. This selector switch SE switches between transmission of the test-access signals from the LB controlling section (5B, 5C, 5D, 5E, or 5F) to the arbitration unit 22A and transmission of the access signals from the external device (21, 23, 24, or 25) to the arbitration unit 22A.

The LB controlling section (5B, 5C, 5D, 5E, or 5F) includes a setting switch 51 for switching the selector switch. This setting switch 51 can be, for example, a DIP switch. When an access conflict test is conducted, the DIP switch 51 is operated by an examiner in advance.

When the system for generating access conflict is in the first operation mode, the selector switches SE in all the interface processing blocks 22B, 22C, 22D, 22E, and 22F are switched to the LB controlling sections 5B to 5F by the corresponding DIP switches 51. That is, test-access signals can be sent from each of the interface processing blocks 22B, 22C, 22D, 22E, and 22F to the arbitration unit 22A.

On the other hand, when the system for generating access conflict is in the second operation mode and one of the interface processing blocks 22B, 22C, 22D, 22E, and 22F, for example, only the processor interface 22B is operated in practice, the selector switch SE is switched to the corresponding external device, i.e., the general-purpose processor 21 by the DIP switch 51.

As shown in FIG. 5, the LB controlling section (5B, 5C, 5D, 5E, or 5F) further includes a selector switch 52, a DIP switch 53, a receiving section 54 via a local bus, and a test-access generating section 55.

The selector switch 52 is switched by the DIP switch 53 in the same manner as the selector switch SE. The selector switch 52 is switched to the receiving section 54 when the first operation mode is selected, and switched to the test-access generating section 55 when the second operation mode is selected.

In the first operation mode, when a test-access signal Sₘ output from the ID determining/access adjusting section 33 of the conflict control unit 3 is received by the receiving section 54 via the selector switch 52 of the LB controlling section 5B of the processor interface 22B, for example, the test-access signal Sₘ is retained in the receiving section 54 of the LB controlling section 5B for a predetermined period. That is, the test-access signal Sₘ is retained in the receiving section 54 of the LB controlling section 5B until the next test-access signal S₍ₘ₊₁₎ is received by the receiving section 54 of, for example, the LB controlling section 5F of the intersystem bus interface 22F via the selector switch 52. When the next test-access signal S₍ₘ₊₁₎ is received by the receiving section 54 of the LB controlling section 5F, the test-access signals Sₘ and S₍ₘ₊₁₎ are simultaneously output from the corresponding receiving sections 54 to the corresponding test-access generating sections 55, and then simultaneously output toward the arbitration unit 22A via the corresponding selector switch SE after the send timing interval t has elapsed.

On the other hand, in the second operation mode, a test-access signal Sₙ output from the ID determining/access adjusting section 33 of the conflict control unit 3 is directly sent toward the test-access generating section 55 via the selector switch 52. Subsequently, the test-access signal Sₙ is output toward the arbitration unit 22A via the selector switch SE after the send timing interval T has elapsed.

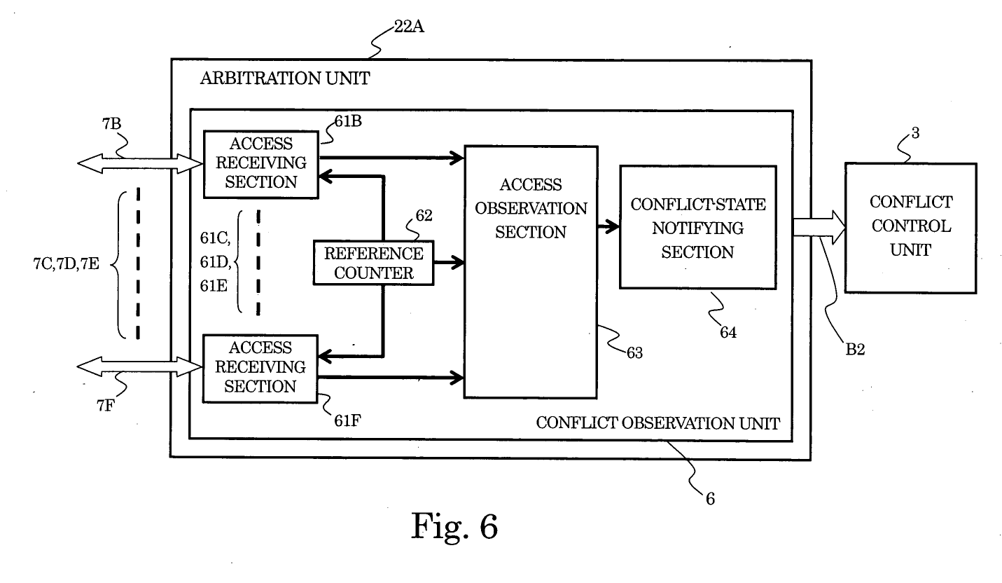

Next, the structure of the conflict observation unit 6 will be described with reference to FIG. 6, which is a detailed block diagram of the conflict observation unit 6 shown in FIG. 1.

The conflict observation unit 6 includes five access receiving sections 61B, 61C, 61D, 61E, and 61F, a reference counter 62 connected to the access receiving sections 61B to 61F, an access observing section 63 connected to the access receiving sections 61B to 61F, and a conflict-state notifying section 64 connected to the access observing section 63.

The access receiving sections 61B to 61F are connected to the LB controlling sections 5B to 5F of the interface processing blocks 22B to 22F via buses 7B, 7C, 7D, 7E, and 7F, respectively. The test-access signals Sₘ or Sₙ output from the LB controlling sections 5B to 5F are received by the access receiving sections 61B to 61F, respectively.

Although not shown in FIG. 6, the buses 7B to 7F are also connected to the arbitration unit 22A, and the test-access signals Sₘ or Sₙ output from the LB controlling sections 5B to 5F are sent to the arbitration unit 22A in addition to the conflict observation unit 6. Moreover, busses for sending real access signals of the interface processing blocks 22B to 22F to the arbitration unit 22A when the interface processing blocks 22B to 22F are operated in practice are also connected to the buses 7B to 7F, respectively. Thus, when one of the interface processing blocks 22B to 22F is operated, the real access signals are also sent to the conflict observation unit 6.

When the system for generating access conflict is in the first operation mode, for example, it is assumed that an access conflict test is conducted using a test-access signal Sₘ output from the processor interface 22B and a test-access signal S₍ₘ₊₁₎ output from the intersystem bus interface 22F. Furthermore, it is assumed that the test-access signal Sₘ output from the LB controlling section 5B of the processor interface 22B is received by the access receiving section 61B before the test-access signal S₍ₘ₊₁₎ output from the LB controlling section 5F of the intersystem bus interface 22F is received by the access receiving section 61F. The reference counter 62 starts counting on the basis of a predetermined clock pulse when the test-access signal Sₘ is received by the access receiving section 61B, and stops counting when the test-access signal S₍ₘ₊₁₎ is received by the access receiving section 61F. At the same time as when the reference counter 62 stops counting, the test-access signals Sₘ and S₍ₘ₊₁₎ are simultaneously output to the access observing section 63. At this moment, the number of count in the reference counter 62 is also output to the access observing section 63 as a time difference Δt.

However, in practice, Δt=0 is satisfied since the test-access signals Sₘ and S₍ₘ₊₁₎ are simultaneously sent from the test-access generating sections 55 of the LB controlling section 5B and the LB controlling section 5F, respectively, toward the arbitration unit 22A via the corresponding selector switch SE after the send timing interval t has elapsed, and the access conflict between the test-access signals Sₘ and S₍ₘ₊₁₎ in the arbitration unit 22A can be reliably ensured. However, Δt can be a value other than zero for some reason.

At any rate, it is determined whether or not an access conflict has occurred in the arbitration unit 22A on the basis of the time difference Δt in the access observing section 63, and information on the conflict state is created using the determination. That is, when Δt=0 is satisfied, it is determined that an access conflict has occurred. On the other hand, when Δt≠0 is satisfied, it is determined that no access conflict has occurred. This determination information corresponds to the information on the conflict state. The information on the conflict state includes command codes and the like of the test-access signals Sₘ and S₍ₘ₊₁₎ in addition to the information on the conflict determination (Δt).

On the other hand, when the system for generating access conflict is in the second operation mode, for example, it is assumed that an access conflict test is conducted using real access signals output from the processor interface 22B in practice and test-access signals Sₙ output from the intersystem bus interface 22F. Furthermore, when the system for generating access conflict is operated after the processor interface 22B is operated, various real access signals are successively output from the processor interface 22B at constant output intervals T_{C}, and the reference counter 62 is reset each time the access receiving section 61B receives a real access signal. That is, when two successive real access signals are successively received by the access receiving section 61B, the reference counter 62 is reset and started when the preceding real access signal is received by the access receiving section 61B, and the reference counter 62 is reset and started again when the succeeding real access signal is received by the access receiving section 61B after a constant output interval T_{C} has elapsed. Therefore, when a test-access signal Sₙ (send timing interval T) output from the intersystem bus interface 22F is received by the access receiving section 61F between the reception of the preceding real access signal and the reception of the succeeding real access signal, the preceding real access signal and the test-access signal Sₙ are output to the access observing section 63, and a time difference ΔT at this moment is defined as follows.

ΔT=T_{C}·T

The description above is based on a premise that a test-access signal Sₙ cannot stochastically conflict with a real access signal at the early stage of the operation of the system for generating access conflict, and an access conflict between another real access signal and the next test-access signal S₍ₙ₊₁₎ can be realized by appropriately adjusting the timing interval T of the next access signal S₍ₙ₊₁₎ using the time difference ΔT obtained using the test-access signal Sₙ. That is, the access conflict between the test-access signal S₍ₙ₊₁₎ and the real access signal can be ensured by adding the time difference ΔT to the send timing interval T of the test-access signal S₍ₙ₊₁₎ such that the sent timing interval of the test-access signal S₍ₙ₊₁₎ correspond to the constant output interval T_{C} of the real access signal.

As is clear from the description above, the send timing interval t or T corresponds to the frequency of clock pulses used by the reference counter 62.

In the access observing section 63, it is determined whether or not an access conflict has occurred in the arbitration unit 22A on the basis of the time difference ΔT, and information on the conflict state is created using the determination. That is, when ΔT=0 is satisfied, it is determined that an access conflict has occurred. On the other hand, when ΔT≠0 is satisfied, it is determined that no access conflict has occurred. This determination information corresponds to the information on the conflict state. The information on the conflict state includes command codes and the like of the real access signal and the test-access signal Sₙ in addition to the information on the conflict determination (ΔT).

Information on the conflict state (Δt or ΔT) created in the access observing section 63 is sent to the conflict-state notifying section 64, and then sent from the conflict-state notifying section 64 to the conflict-information processing section 34 of the conflict control unit 3 (see FIG. 2) via the local bus B2. Pieces of information on the conflict state (Δt or ΔT) are successively stored and accumulated in the conflict-information processing section 34. The information on the conflict state (Δt or ΔT) can be checked via the test terminal P3.

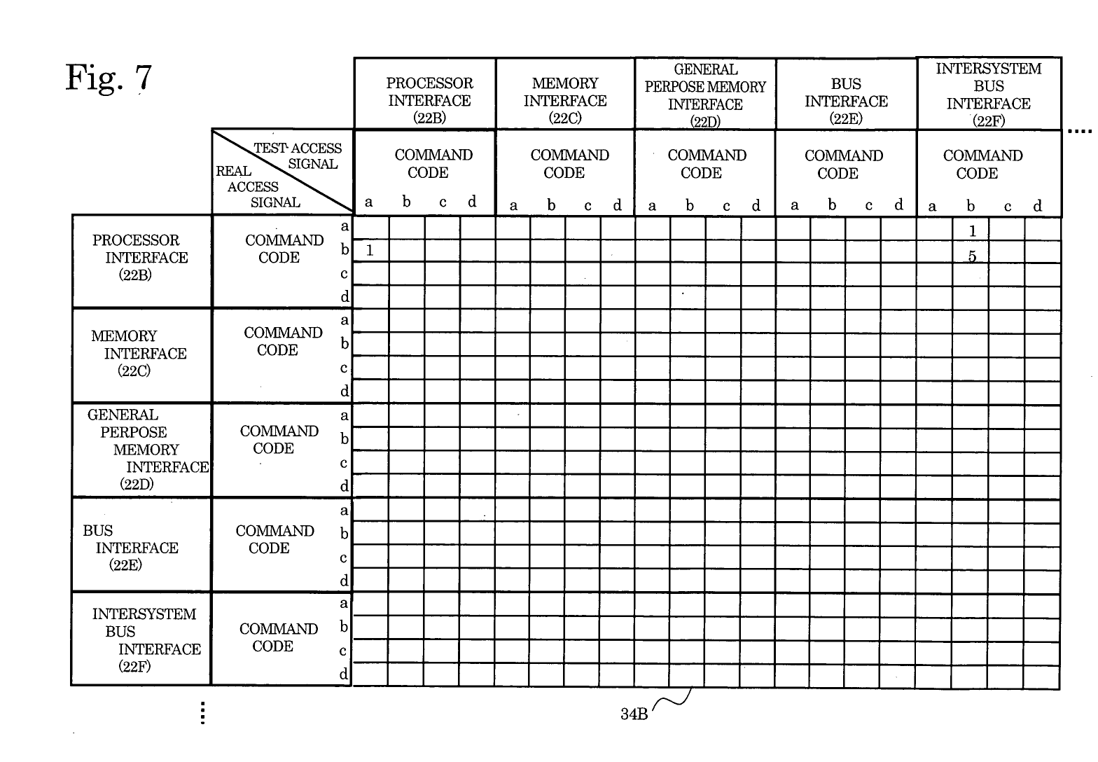

The conflict-generation setting register 34B in the conflict control unit 34 is schematically and illustratively shown in FIG. 7. In FIG. 7, the command codes of the real access signals obtained from the various interfaces 22B, 22C, 22D, 22E, and 22F are identified as a, b, c, or d. Similarly, the command codes of the test-access signals obtained from the internal memory 31 are identified as a, b, c, or d. For example, the command code a indicates that the real access signals or the test-access signals are read command signals, the command code b indicates that the real access signals or the test-access signals are write command signals, the command code c indicates that the real access signals or the test-access signals are interrupt command signals, and the command code d indicates that the real access signals or the test-access signals are command signals other than those described above. Each region for the command code has four bits for command code identification. In FIG. 7, the dotted lines show that the other units to be tested for conflict access can be added.

For example, when the system for generating access conflict is in the second operation mode, a real access signal is sent from the processor interface 22B to the arbitration unit 22A as a read signal (a), and a test-access signal Sₙ is sent from the intersystem bus interface 22F to the arbitration unit 22A as a write signal (b). Furthermore, the real access signal and the test-access signal do not conflict with each other, and a time difference ΔT of “5” is obtained. In this case, the information on the conflict state output from the conflict observation unit 6 is written in the conflict-generation setting register 34B as shown in FIG. 7. That is, “1” is written in a bit corresponding to the command code a (read signal) of the processor interface 22B that outputs the real access signal, “1” is written in a bit corresponding to the command code b (write signal) of the processor interface 22B that outputs the test-access signal, and “5” is written in a region corresponding to both the above-described bits as a time difference ΔT. Herein, ΔT=5 corresponds to the frequency of clock pulses used by the reference counter 62 (see FIG. 6).

When the information on the conflict state is written in the conflict-generation setting register 34B in this manner, it is determined whether or not the time difference ΔT is zero in the access-conflict determining circuit 34C. When ΔT≠0 is satisfied, the time difference ΔT=5 is output from the conflict-generation setting register 34B to the send-timing adjusting circuit 33C of the ID determining/access adjusting section 33 as a correction time.

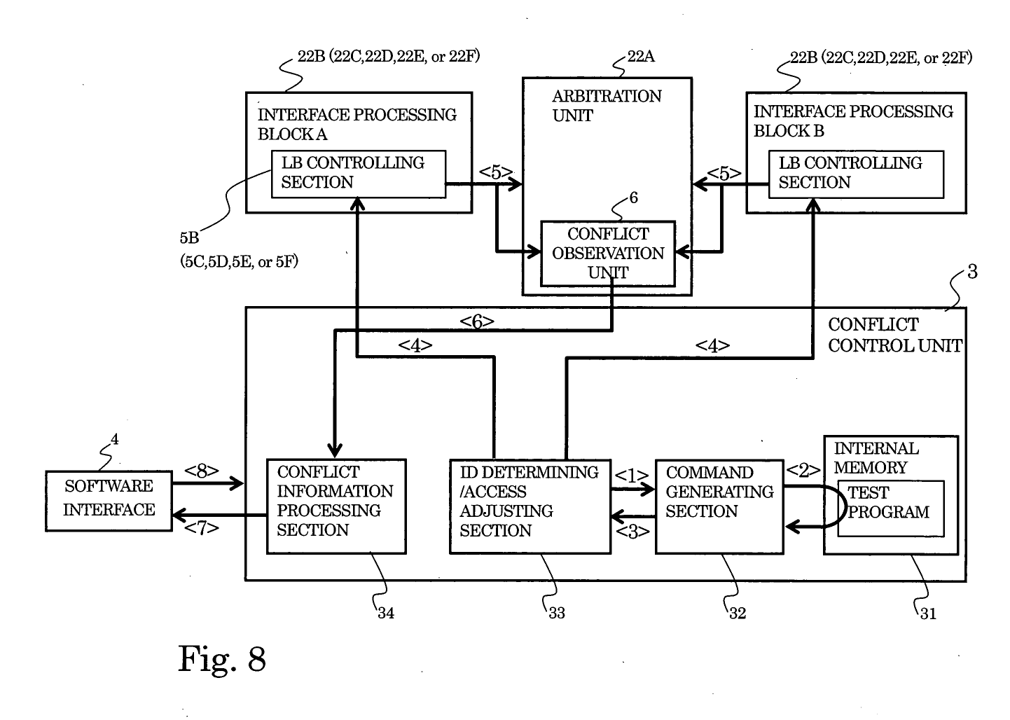

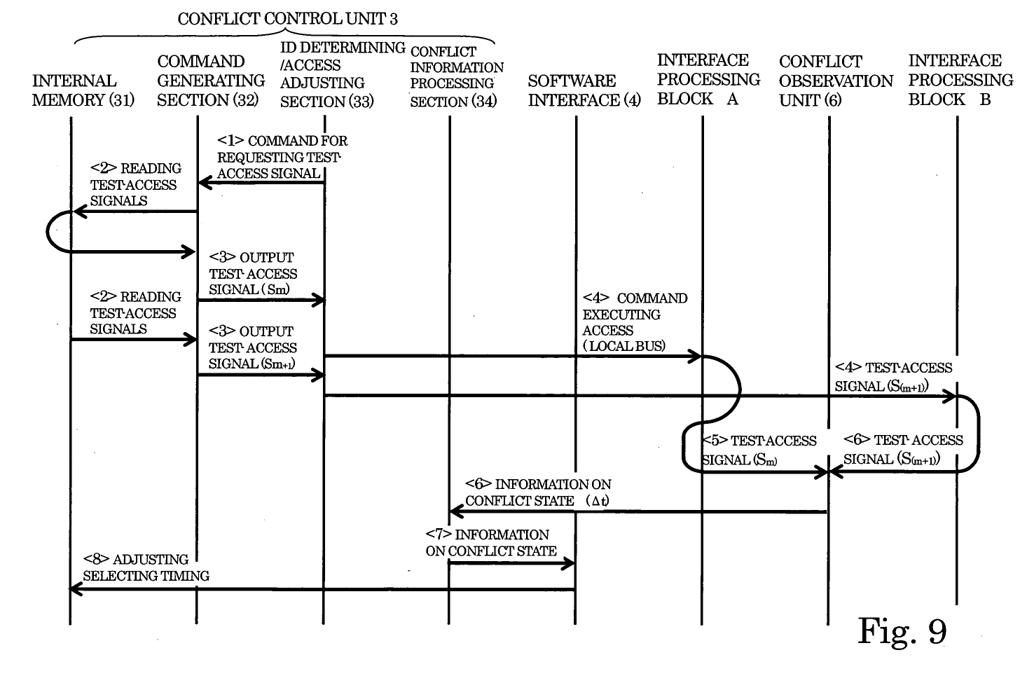

Next, an access conflict test conducted by operating the system for generating access conflict in the first operation mode will be described with reference to FIGS. 8 and 9, which illustrate operations of the system and the sequence thereof, respectively. In FIG. 8, steps <1> to <8> conducted during the access conflict test are shown using arrows numbered in chronological order. These steps <1> to <8> correspond to steps <1> to <8> shown in FIG. 9, respectively. Whether the system for generating access conflict is operated in the first operation mode or in the second operation mode is selected at the test terminal P3. When the first operation mode is selected, the test-access signals having the packet formats as shown in FIG. 3 has been already prepared in the internal memory 31 of the conflict control unit 3.

In FIG. 8, interface processing blocks A and B represent any two of the interface processing blocks 22B, 22C, 22D, 22E, and 22F. For example, the interface processing block A is the processor interface 22B, and the interface processing block B is the intersystem bus interface 22F.

When a command to start an access conflict test is output from the test terminal P3 to the conflict control unit 3, the system for generating access conflict autonomously starts operating.

First, when a command for requesting test-access signals is output from the ID determining/access adjusting section 33 of the conflict control unit 3 to the command generating section 32 at a predetermined timing in step <1>, the command generating section 32 successively reads test-access signals Sₘ from the internal memory 31 at predetermined time intervals, and decodes the contents of the command codes (H3) into the access format of the processor module 2 in step <2>. Subsequently, the command generating section 32 successively outputs the test-access signals Sₘ to the ID determining/access adjusting section 33 in step <3>.

The destination-block determining circuit 33A in the ID determining/access adjusting section 33 successively determines the destinations of the test-access signals Sₘ from the block IDs (H2) thereof, and the test-access signals Sₘ are successively output to the LB controlling sections (5B, 5C, 5D, 5E, and 5F) of the predetermined interface processing blocks (22B, 22C, 22D, 22E, and 22F) via the selector switch 33B in step <4>. As described above, the send timing interval t of the test-access signals Sₘ is not substantially adjusted by the send-timing adjusting circuit 33C in the first operation mode.

In the first operation mode, when a test-access signal Sₘ is sent to the LB controlling section (5B, 5C, 5D, 5E, or 5F) of the interface processing block A, the test-access signal Sₘ is sent to the receiving section 54 via the selector switch 52 (see FIG. 5).

For example, when the test-access signal Sₘ is received by the receiving section 54 of, for example, the LB controlling section 5B of the processor interface 22B, i.e., the interface processing block A, the test-access signal Sₘ is retained for a predetermined period. That is, the test-access signal Sₘ is retained at the receiving section 54 of the LB controlling section 5B until the next test-access signal S₍ₘ₊₁₎ is received by the receiving section 54 of, for example, the LB controlling section 5F of the intersystem bus interface 22F, i.e., the interface processing block B via the corresponding selector switch 52. When the next test-access signal S₍ₘ₊₁₎ is received by the receiving section 54 of the LB controlling section 5F, the test-access signals Sₘ and S₍ₘ₊₁₎ are output from the corresponding receiving sections 54 to the corresponding test-access generating sections 55. The processes of the test-access signals S₍ₘ₊₁₎ in steps <2> to <4> are the same as those of the test-access signals Sₘ.

Next, in step <5>, the test-access signals Sₘ and S₍ₘ₊₁₎ are sent from the corresponding test-access generating sections 55 toward the arbitration unit 22A via the corresponding selector switch SE after the send timing interval t has elapsed, and are input to both the arbitration unit 22A and the conflict observation unit 6 (see FIG. 6).

The test-access signals Sₘ and S₍ₘ₊₁₎ are received by the corresponding access receiving sections (two of 61B, 61C, 61D, 61E, and 61F) of the conflict observation unit 6. For example, when it is assumed that the test-access signal Sₘ is received by the access receiving section 61B and the test-access signal S₍ₘ₊₁₎ is received by the access receiving section 61F, the number of count in the reference counter 62 is output to the access observing section 63 as a time difference Δt as described above. At the same time, the test-access signals Sₘ and S₍ₘ₊₁₎ are also output to the access observing section 63. Information on the conflict state is created at the access observing section 63 on the basis of the time difference Δt. As described above, when Δt=0 is satisfied, it is determined that an access conflict has occurred. On the other hand, when Δt≠0 is satisfied, it is determined that no access conflict has occurred. This determination information is included in the information on the conflict state. The information on the conflict state further includes command codes or the like of the test-access signals Sₘ and S₍ₘ₊₁₎. In the first operation mode, Δt=0 is satisfied under normal conditions.

In step <6>, the information on the conflict state (Δt) is sent from the conflict-state notifying section 64 to the conflict-information processing section 34 of the conflict control unit 3 via the local bus B2. Pieces of information on the conflict state (Δt) are successively accumulated in the memory 34A of the conflict-information processing section 34. When all the test-access signals are read from the program for the access conflict test stored in the internal memory 31 of the conflict control unit 3, all pieces of information on the conflict state (Δt) are accumulated in the memory 34A, and the operation of the system for generating access conflict is temporarily stopped.

In step <7>, an examiner checks the information on the conflict state retrieved from the memory 34A via the software interface 4 at the test terminal P3, and analyzes the information on the conflict state at the test terminal P3 together with the information on the results of processing of the access conflict obtained at the test terminal P2.

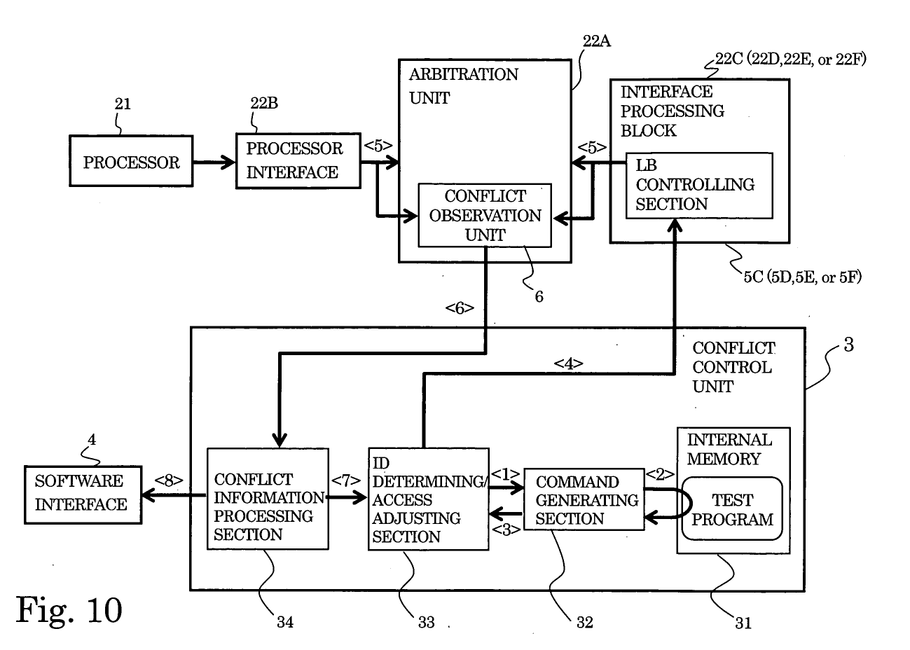

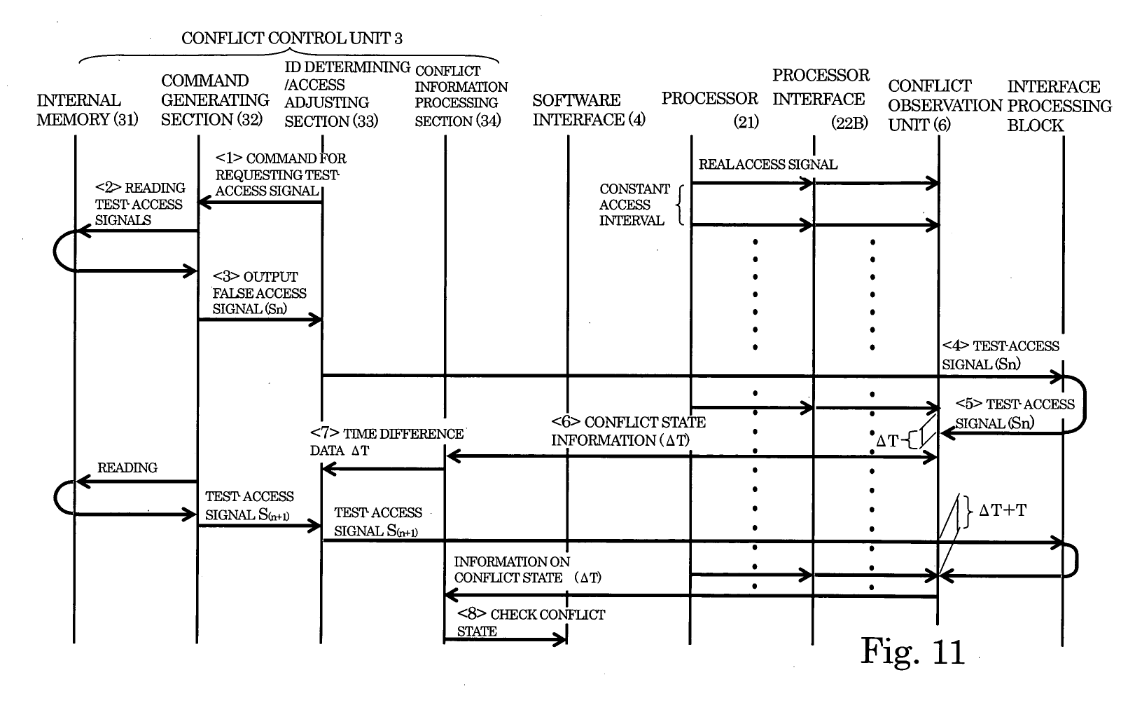

Next, an access conflict test conducted by operating the system for generating access conflict in the second operation mode will be described with reference to FIGS. 10 and 11, which illustrate operations of the system and the sequence thereof, respectively. In FIG. 10, steps <1> to <8> conducted during the access conflict test are shown using arrows numbered in chronological order. These steps <1> to <8> correspond to steps <1> to <8> shown in FIG. 11, respectively. Whether the system for generating access conflict is operated in the first operation mode or in the second operation mode is selected at the test terminal P3. When the second operation mode is selected, the test-access signals having the packet format as shown in FIG. 4 has been already prepared in the internal memory 31 of the conflict control unit 3.

In an example shown in FIGS. 10 and 11, the general-purpose processor 21 is operated in practice in accordance with a predetermined program. Real access signals successively output therefrom at predetermined constant intervals are sent to the arbitration unit 22A via the processor interface 22B, and at the same time, sent to the access receiving section 61B of the conflict observation unit 6 via the bus 7B. At this moment, the reference counter 62 is reset and started each time a real access signal is received by the access receiving section 61B as described above.

When a command to start an access conflict test is output from the test terminal P3 to the conflict control unit 3, the system for generating access conflict autonomously starts operating.

First, when a command for requesting test-access signals is output from the ID determining/access adjusting section 33 of the conflict control unit 3 to the command generating section 32 at a predetermined timing in step <1>, the command generating section 32 successively reads test-access signals Sₙ from the internal memory 31 at predetermined time intervals, and decodes the contents of the command codes (H3) into the access format of the processor module 2 in step <2>. Subsequently, the command generating section 32 successively outputs the test-access signals Sₙ to the ID determining/access adjusting section 33 in step <3>.

The destination-block determining circuit 33A in the ID determining/access adjusting section 33 successively determines the destinations of the test-access signals Sₙ from the block IDs (H2) thereof. Moreover, the send timing intervals T of the test-access signals Sₙ are corrected at the ID determining/access adjusting section 33 using send-timing correction values. The send-timing correction value at the early stage is set to zero.

The test-access signals Sₙ are successively output to the LB controlling sections (5B, 5C, 5D, 5E, and 5F) of the predetermined interface processing blocks (22B, 22C, 22D, 22E, and 22F) via the selector switch 33B in step <4> (see FIG. 5).

In the second operation mode, when a test-access signal Sₙ is sent to the LB controlling section (5C, 5D, 5E, or 5F) of the interface processing block A, the test-access signal Sₙ is directly output from the selector switch 52 to the test-access generating section 55 as described above. In step <5>, the test-access signal Sₙ is sent from the corresponding test-access generating section 55 to both the arbitration unit 22A and the conflict observation unit 6 after the send timing interval T has elapsed (see FIG. 6).

For example, when the test-access signal Sₙ is received by the access receiving section 61F of the conflict observation unit 6, the number of count in the reference counter 62 is output to the access observing section 63 as a time difference ΔT. At the same time, the test-access signal Sₙ is output to the access observing section 63 together with the real access signal that is received by the access receiving section 61B at this moment. Information on the conflict state is created at the access observing section 63 on the basis of the time difference ΔT. As described above, when ΔT=0 is satisfied, it is determined that an access conflict has occurred. On the other hand, when ΔT≠0 is satisfied, it is determined that no access conflict has occurred. This determination information is included in the information on the conflict state. The information on the conflict state further includes command codes or the like of the real access signal and the test-access signal Sₙ.

In step <6>, the information on the conflict state (ΔT) is sent from the conflict-state notifying section 64 to the conflict-information processing section 34 of the conflict control unit 3 via the local bus B2. Pieces of information on the conflict state (ΔT) are successively accumulated in the memory 34A of the conflict-information processing section 34, and are written in the conflict-generation setting register 34B. When a piece of information on the conflict state (ΔT) is written in the conflict-generation setting register 34B, it is determined whether or not the time difference ΔT is zero in the access-conflict determining circuit 34C.

In step <7>, when ΔT≠0 is satisfied, the time difference ΔT is output from the conflict-generation setting register 34B to the send-timing adjusting circuit 33C of the ID determining/access adjusting section 33 as a correction time (see FIG. 7). When ΔT=0 is satisfied, the time difference data, i.e., the time difference ΔT is not output to the send-timing adjusting circuit 33C.

In the send-timing adjusting circuit 33C, the send timing interval T of the next test-access signal S₍ₙ₊₁₎ output from the command generating section 32 is adjusted using the send-timing correction value ΔT. That is, as described above, the adjustment of the send timing interval T is conducted by calculating the followings.

T+ΔT=T_{C}

Subsequently, the test-access signal S₍ₙ₊₁₎ is processed in the same manner as the test-access signal Sₙ (steps <4> and <5>), and the information on the conflict state (ΔT) is sent from the conflict observation unit 6 to the conflict-information processing section 34 of the conflict control unit 3 (step <6>). The information on the conflict state is processed in the same manner as that obtained from the test-access signal Sₙ (step <7>). In the second operation mode, readout of the program for the conflict test from the internal memory 31 of the conflict control unit 3 is repeated at least two times. With this, all the test-access signals Sₙ can conflict with the real access signals output from the processor interface 22B.

In step <8>, an examiner checks the information on the conflict state retrieved from the memory 34A via the software interface 4 at the test terminal P3, and analyzes the information on the conflict state at the test terminal P3 together with the information on the results of processing of the access conflict obtained at the test terminal P2.

What is claimed is:

1. A system for generating access conflict embedded in a device including an arbitration unit and first and second interfaces, the system comprising:
a storage for storing information for generation of a first and a second test access signals to simulate real access signals and information of time intervals for generation of the first and second test access signals, the test access signals being outputted from the first and second interfaces, respectively;
a first and a second local bus controller for controlling the first and second interfaces, respectively;
a test access signal outputting part for successively outputting the first and second test access signals to the first and second local bus controllers at a time interval in accordance with the information in the storage, respectively;
an access observer for observing operation of the arbitration unit; and
a test access generator for sending each of the first and second test access signals, respectively, to the access local bus controlling parts for sending the first and second test access signals, respectively, to the access observer on the basis of the send timing interval.

2. The system for generating access conflict according to claim 1, wherein the time interval is set to a longer processing time of a processing time required for a real access signal to be processed at the first interface and a processing time required for a real access signal to be processed at the second interface.

3. The system for generating access conflict according to claim 1 or 2, wherein the test access signal outputting part comprises a command generator that generates a read command to read the information for generation of the first and second test access signals from the storage and a destination determining part for determining each destination of the information for generation of the first and second test access signals.

4. The system for generating access conflict according to claim 1 or 2, further comprising a time difference generator for generating a time difference between each arrival of the first and second test access signals at the access observer.

5. The system for generating access conflict according to claim 4, further comprising a time difference accumulator for accumulating the time difference.

6. A system for generating access conflict embedded in a device including an arbitration unit and a first and a second interfaces, the system comprising:
a storage for storing information for generation of a first and a second test access signals to simulate real access signals and information of time for generation of the first and second test access signal;
a first local bus controller for controlling the first local interface;
a second local bus controller for controlling the second local interface, the second local bus controller receiving the real access signals from the second interface at a constant time interval;
a test access signal outputting part for outputting the first and the second test access signals to the first local bus controller;
an access observer for observing operation of the arbitration unit;
a time difference generator for generating a time difference between the constant time interval and a time of transmission of the first test access signal from the first local bus controller to the access observer, the time of transmission of the first test access signal being in accordance with the information of time; and
a transmission time interval adjuster for adjusting a time of transmission of the second test access signal from the first local bus controller to the access observer on the basis of the time difference.

7. The system for generating access conflict according to claim 6, wherein a time interval between the times of transmission of the first test access and the second access signals from the first local bus controller to the access observer is set to a value smaller than the constant interval.

8. The system for generating access conflict according to claim 6 or 7, wherein the test access signal outputting part comprises a command generator for generating read commands to read the information of the first and the second test access signals from the storage and a destination determining part for determining destinations of the test access signals.

9. The system for generating access conflict according to claim 6, further comprising a time difference accumulating part for accumulating the time difference.

10. A system having an arbitration unit comprising:
a storage for storing information for generation of a first and a second test access signals to simulate real access signals and information of time intervals for generation of the first and the second test access signals, the test access signals being outputted from a first and a second interfaces, respectively;
a first and a second local bus controller for controlling the first and second interfaces, respectively;
a test access signal outputting part for successively outputting the first and second test access signals to the first and second local bus controllers at a time interval in accordance with the information in the storage, respectively;
an access observer for observing operation of the arbitration unit; and
a test access generator for sending each of the first and second test access signals, respectively, to the access local bus controlling parts for sending the first and second test access signals, respectively, to the access observer on the basis of the send timing interval.
